(19) United States
(12) Patent Application Publication
(10) Pub. No.: US 2004/0184639 A1
(43) Pub. Date: Sep. 23, 2004

(54) Method and apparatus for the automated inspection and grading of fabrics and fabric samples

(75) Inventors: Tobias McMullen Jackson, Brooklyn, NY (US); James Knapp, New York, NY (US); Dale Szabo, Brooklyn, NY (US)

Correspondence Address: Nicholas J. Tuccillo, Esq., McCormick, Paulding & Huber LLP, 185 Asylum Street, CityPlace II, Hartford, CT, 06103, US

(73) Assignee: LINETECH INDUSTRIES, INC., Brooklyn, NY

(21) Appl. No.: 10/782,647

(22) Filed: Feb. 19, 2004

Related U.S. Application Data
(60) Provisional application No. 60/447,910, filed on Feb. 19, 2003.

(51) Int. Cl. H04N 9/47

(52) U.S. Cl. 382/111; 348/88

(57) ABSTRACT

A automated pilling, snag, and fuzziness inspection and grading method and apparatus for quantifying, locating, and sizing pills, snags, and/or fuzz on fabric rolls or fabric sample swatches, which includes a fulcrum about which the fabric is bent, the fulcrum defining an apex portion in the fabric where the fulcrum contacts the fabric. A moving mechanism is provided for moving a length of the fabric across the fulcrum causing the apex portion to be temporally redefined along the length of the moving fabric. An illumination mechanism is provided for projecting a light upon one side of the temporally redefined apex portion and a recording device is also provided for recording a horizon image of the temporally redefined apex portion where the horizon image being back lit by the illumination mechanism.

### CROSS REFERENCED TO RELATED APPLICATIONS

This application claims priority to U.S. Provisional Application Serial No. 60/447,910, filed on Jan. 19, 2003 and herein incorporated by reference in its entirety

### FIELD OF THE INVENTION

This invention relates in general to a method and apparatus for the automated inspection and grading of fabric and fabric samples, and deals more particularly with an automated camera inspection system for identifying and grading pilling, snagging, fuzziness and coloration of fabrics and fabric samples.

### BACKGROUND OF THE INVENTION

It is often necessary in the textile arts to inspect and grade fabrics and fabric samples. Such inspection and grading enables quality control, and can provide the basis for determining whether a particular fabric is suitable for a predetermined use.

Over the years, various organizations in the textile supply chain, including fiber and yarn manufacturers, fabric distributors, testing service laboratories, clothing designers and retail quality control laboratories, have often sought to inspect fabric and fabric swatches, or samples, for pills, hairiness (fuzziness) and snagging. Pills are bunches or balls of tangled fibers that are created on the fabric by abrasion, typically over extended periods of time after the fabric is being worn or used by the user. Fuzz is the hairs and filaments of a fabric that protrude from the fabric surface. Fuzz is also sometimes referred to as hairiness and nap. Snags are small pulled holes created by sharp objects which may have been projected into and out of the fabric.

Known fabric inspection typically occurred either during the initial production of the fabric, or subsequent to the fabric undergoing a laboratory wear process, inclusive of abrasion techniques and washings, to simulate long term wear. As is known in the art, laboratory wear processes utilize industry standard abrasion techniques such as the Martindale™, Milner™, Random Tumbler™, Snagging Machine™, and Pilling BOX™ abrasion techniques, many of which are specified under standardized organizational testing procedures.

After the wear process, a human inspector will optically grade the degree of pilling, snagging and/or hairiness, typically on a scale of 1 to 5, where 5 indicates a low or non-existent degree of pilling, snagging and/or abrasion, and 1 indicates a high or severe degree of pilling, snagging and/or fuzziness.

As will be appreciated, the major drawback of such methods is that the human grading of such characteristics is inherently subjective. One inspector can grade quite differently than another, and the fabric manufacturer can grade differently than the fabric customer, thereby disallowing any useful correlation of important quality control data of fabrics and textiles.

Attempts have been made in the past to automatically inspect pills using camera technologies looking down upon the flat, planar surface of the fabric, however these efforts were hampered by, among other difficulties, the existence of various colors and patterns on the surface of the fabric, confusing the detection of pills, snags, and fuzz with the imaging of colors and patterns.

With particular respect to the coloration of fabrics, packages and fabrics are produced in both solid color and multi-colored forms. Prior to shipping of packages or fabrics, it is imperative that the color is consistent throughout the quantity of packages and fabrics on both an inter and intra basis. Currently, packages are inspected for defects and conformity to specifications by human operators and, in some cases, automated inspection systems. However, there is no current automated color inspection system that adequately detects slight color differences across a substantial 2-dimensional spatial area of the package or fabric.

One known automated color inspection system utilizes high spectral resolution spectrophotometers of a variety of types. The major drawback of this technology, however, is that spectrophotometers are inherently single point inspection devices, where the spectral measurement of a single point ranging from a diameter of 0.001 mm to 10.0 mm takes approximately 1 second to measure. This technology is well suited to numerous applications, such as color matching, but the technology is not suited for measuring color at many points across a large spatial area.

Another known automated color inspection system utilizes a color camera of various types. Color cameras offer the required advantages of large spatial area processing within a reasonable time period, however, this technology fails to detect slight color differences due to the inherent lack of spectral resolution offered by red, green, and blue base color parameters, in effect offering a color resolution of only 100 nm, as opposed to the typical color resolution of 10 nm for spectrophotometers.

Thus, existing attempts to objectively judge the coloration of fabrics and fabric swatches have also fallen short of the level of objective evaluation necessary in the art.

With the forgoing problems and concerns in mind, it is the general object of the present invention to provide an automated pilling, snagging, fuzziness and coloration inspection and grading method and apparatus that significantly improves upon the inspection and grading capabilities and speed of known methodologies and systems.

### OBJECTS AND SUMMARY OF THE INVENTION

It is an object of the present invention to provide a method and apparatus for the automated pilling inspection of sample fabric swatches to inspect and grade pill formation and resistance.

It is an object of the present invention to provide a method and apparatus for the automated snagging inspection of sample fabric swatches to inspect and grade snag formation and resistance.

It is an object of the present invention to provide a method and apparatus for the automated fuzziness inspection of sample fabric swatches to inspect and grade fuzz formation and resistance.

It is an object of the present invention to provide a method and apparatus for the automated fuzziness inspection of fabrics as they are rolled or processed on a textile manufacturing machine to inspect, grade, and detect fuzziness formation. This is also known as nap formation, typical to the manufacture of fleece and carpet backing, among other textiles.

It is another object of the present invention to provide a method and apparatus for illuminating the fabric and/or fabric swatch with back-light for capturing the images of the fabric or fabric swatch with a light sensor.

It is another object of the present invention to provide a method and apparatus for illuminating the fabric and/or fabric swatch with front light for capturing the images of the fabric or fabric swatch with a light sensor.

It is another object of the present invention to provide an imaging method so as to capture a back-lighted silhouette-type image of the horizon of the fabric area or fabric swatch which allows acquisition of images that are completely independent of fabric color and fabric pattern.

It is another object of the present invention to provide a mandrel to clamp and rotate the fabric swatch through the camera's field of view so that the camera images the entire three-dimensional swatch surface over a time period.

It is another object of the present invention to provide a mandrel to bend the fabric such that the pills, fuzz, and snags are silhouetted against the back light rather than being silhouetted against pills, fuzz, and snags that are located closer or further to the imaging device.

It is another object of the present invention to provide a method and apparatus for reflecting said silhouette image using a first-surface mirror to improve the ergonomic feeding of the fabric into the mandrel.

It is another object of the present invention to provide a method and apparatus for using an optical filter on the camera lens to eliminate stray light and improve image contrast of the fabric or fabric swatch horizon.

It is another object of the present invention to present each captured frame individually to the image processing method and algorithm

It is another object of the present invention to provide an algorithm and image processing method to locate, quantify, and geometrically measure pills, fuzz, and snags in each video image of the fabric.

It is another object of the present invention to detect the fabric baseline using a imaging tare procedure to set a baseline for any particular type or construction of fabric, where the baseline is the line dividing the black (fabric) and the white (back light) and which represents the cross-sectional geometry of the fabric.

It is another object of the present invention to detect pills in the image by detecting black blobs present above the image's baseline.

It is another object of the present invention to detect snags in the image by detecting black blobs present above the image's baseline.

It is another object of the present invention to detect fuzz by detecting tangled black thin filaments present above the image's baseline using the back light illumination method.

It is another object of the present invention to detect fuzz by detecting white tangled white thin filaments present above the image's baseline when using the front light illumination method.

It is another object of the present invention to provide a correlation equation to convert the obtained pill, snag, and fuzz quantity, location, and size data to the industry standard 1-5 grading scale.

It is another object of the present invention to combine a pilling abrasion apparatus (home laundry, Martindale, Milner, random tumble tester or other) with the automated pilling inspection and grading apparatus to achieve a continuous testing apparatus.

According to one embodiment of the present invention, an automated inspection and grading method for counting (quantifying), locating, and sizing pills, and/or snags and/or fuzz in other embodiments of the present invention, on fabrics includes a motorized fixture which rolls the fabric through the camera's field of view while forming a hump-back like peak across the fabric web movement, while back-illuminating the fabric, while sensing and recording images of the illuminated fabric's horizon. The method further includes evaluating the recorded image to determine the quantity, location, and size of pills on the fabric to thereby assign an objective pilling resistance grade.

It is another object of the present invention to provide a method and apparatus for the automated color inspection of packages and fabrics on both an intra and inter basis.

It is another object of the present invention to provide a method and apparatus for illuminating the package and fabric with light for capturing the images of the packages and fabrics with a light sensor.

It is another object of the present invention to provide a method and apparatus for using an optical slit and prism module to disperse the object-reflected light into a spectral array along the vertical or horizontal axis of an area scan image sensor.

It is another object of the present invention to provide a method and apparatus for arranging the optical slit in line with the horizontal (or vertical) axis of an area scan image sensor so that the left (or top) side of the sensor contains the spectral information of the left (or top) spatial side of the object, and so that the right (or bottom) side of the sensor contains the spectral information of the right (or bottom) spatial side of the object.

It is another object of the present invention to repeat this spatial-spectral image and processing at a continuous rate while the package or fabric is rotated or traversed through the apparatus' field of view in order to provide real-time on-going spatial-spectral data and inspection over the entire, or substantial, surface area of the package or fabric.

It is another object of the present invention to provide an algorithm and image processing method to convert the grayscale video image into useful spectral data of the package and fabric surface on an intra-package (bulls-eyes) and an intra-fabric (streaks) basis.

It is another object of the present invention to provide an algorithm and image processing method to convert the grayscale video image into useful spectral data of the package and fabric surface on an inter-package and an inter-fabric basis.

It is another object of the present invention to provide an algorithm and image processing method to convert the grayscale video image into industry standard color measurement protocol, such as CIE-Lab, CIE-Lch, deltaE, etc.

It is another object of the present invention to provide a monochromatic vision sensor to record the reflected image for the purpose of measuring lightness (as opposed to hue).

It is another object of the present invention to combine the color data and the lightness data to create unique color data fingerprint of the object.

According to another embodiment of the present invention, a color inspection method for detecting color differences of packages and fabrics includes illuminating the package or fabric while sensing and recording a spatial-spectral image of the illuminated yarn package. The method further includes evaluating the recorded image in accordance with predetermined criteria to determine thereby whether the recorded image indicates the presence of any color abnormalities in the yarn package.

These and other objectives of the present invention, and their preferred embodiments, shall become clear by consideration of the specification, claims and drawings taken as a whole.

### BRIEF DESCRIPTION OF THE DRAWING

FIG. 1 illustrates a fabric inspection and grading apparatus according to one embodiment of the present invention.

FIG. 2A illustrates a mandrel assembly, a lighting device and recording apparatus of the fabric inspection and grading apparatus of FIG. 1, according to one embodiment of the present invention.

FIG. 2B illustrates a mandrel assembly, a lighting device and recording apparatus of the fabric inspection and grading apparatus of FIG. 1, according to another embodiment of the present invention.

FIG. 3 illustrates the conversion of obtained pill, snag, and fuzz images generated by the fabric inspection and grading apparatus of FIG. 1, according to one embodiment of the present invention.

FIG. 4A illustrates an image of a fabric exhibiting virtually no pills and snags.

FIG. 4B illustrates an image of a fabric exhibiting moderate pilling and snagging.

FIG. 4C illustrates an image of a fabric exhibiting severe pilling and snagging.

FIG. 5A illustrates a back-lit image of a fabric exhibiting fuzziness.

FIG. 5B illustrates a front-lit image of the fuzziness exhibited in FIG. 5A.

FIG. 6 illustrates a binarization of the fuzziness exhibited in FIGS. 5A and 5B.

FIG. 7 illustrates a hand-held fabric inspection and grading apparatus according to one embodiment of the present invention.

FIG. 8 illustrates a hand-held fabric inspection and grading apparatus according to another embodiment of the present invention.

FIG. 9 illustrates a coloration inspection and detection apparatus, in accordance with one embodiment of the present invention.

FIG. 10 illustrates the working of the coloration inspection and detection apparatus shown in FIG. 9.

FIG. 11 illustrates a graph generated by an image processing algorithm, the algorithm being utilized to process the image obtained from the coloration inspection and detection apparatus of FIGS. 9 and 10.

### DETAILED DESCRIPTION OF THE PREFERRED EMBODIMENT

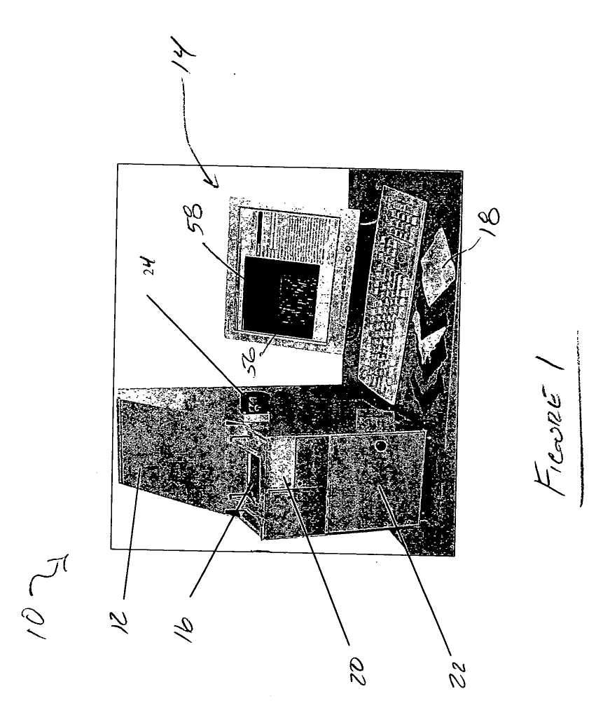

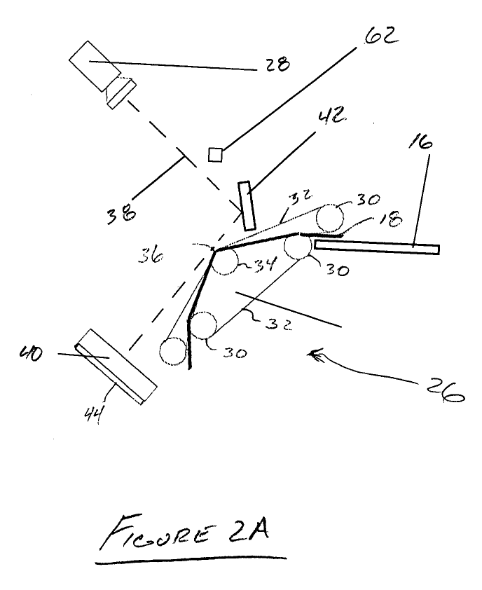

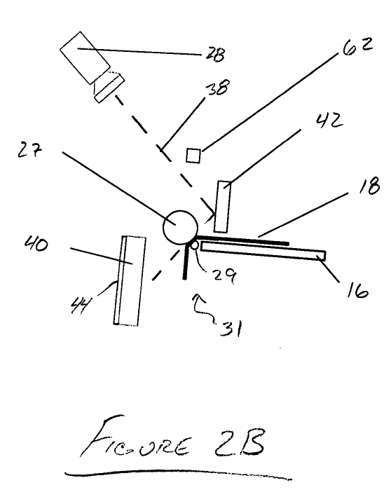

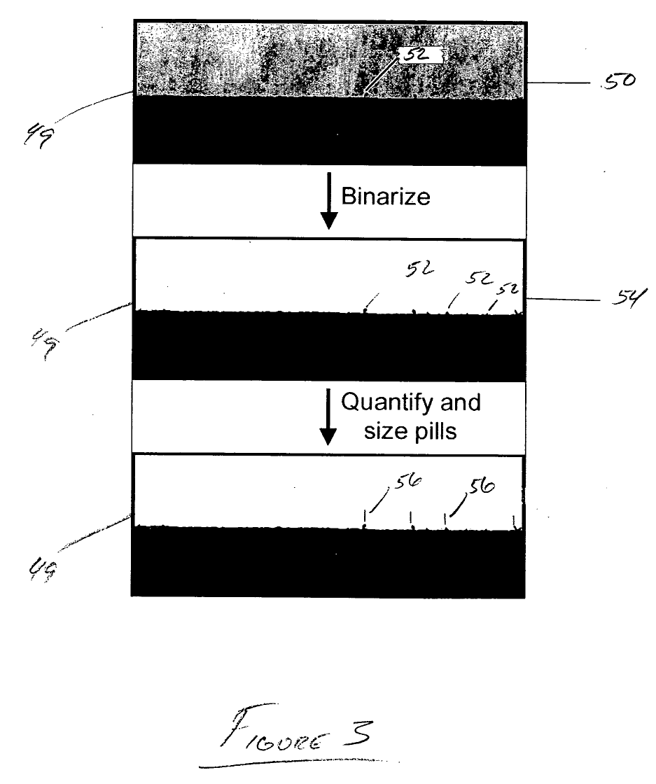

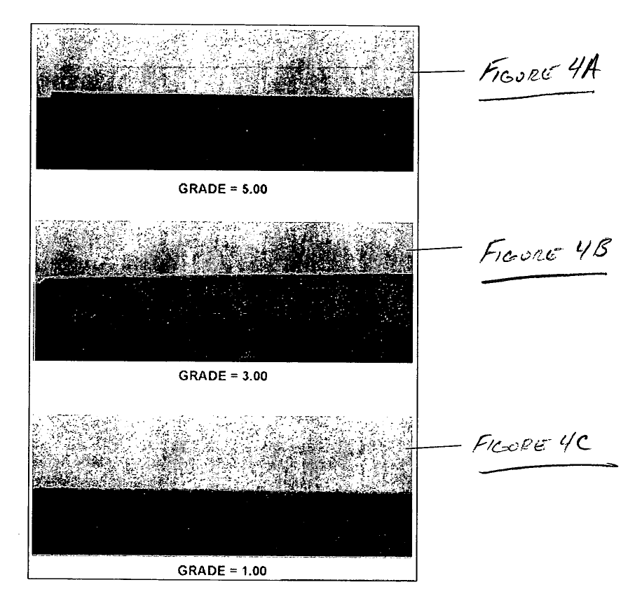

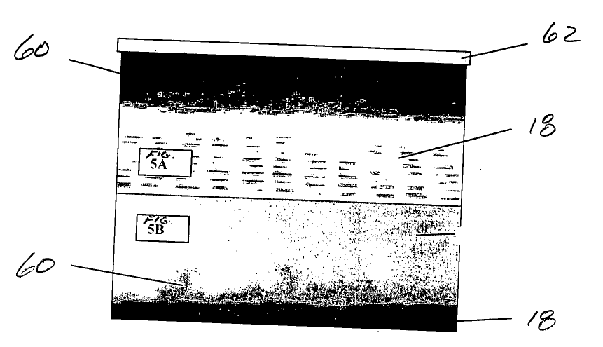

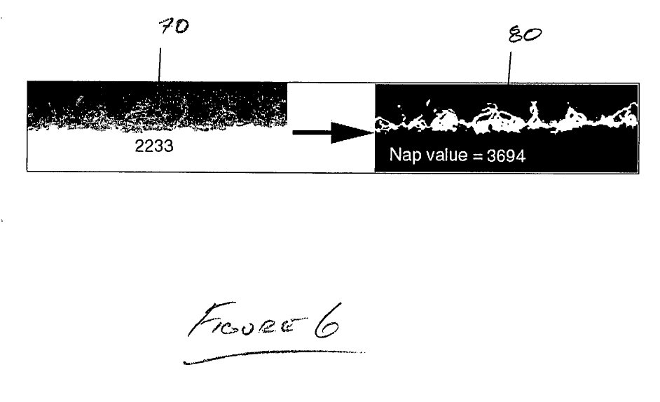

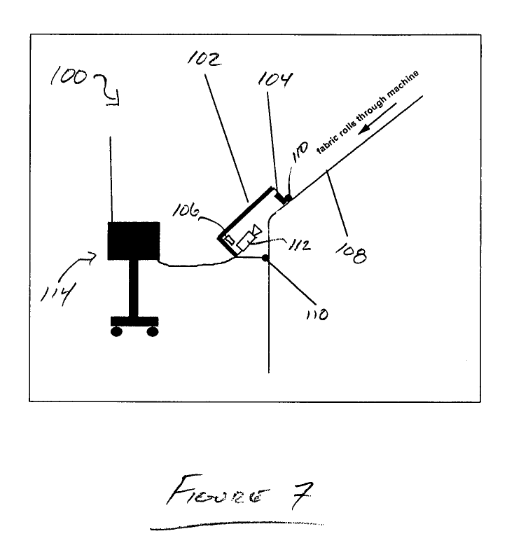

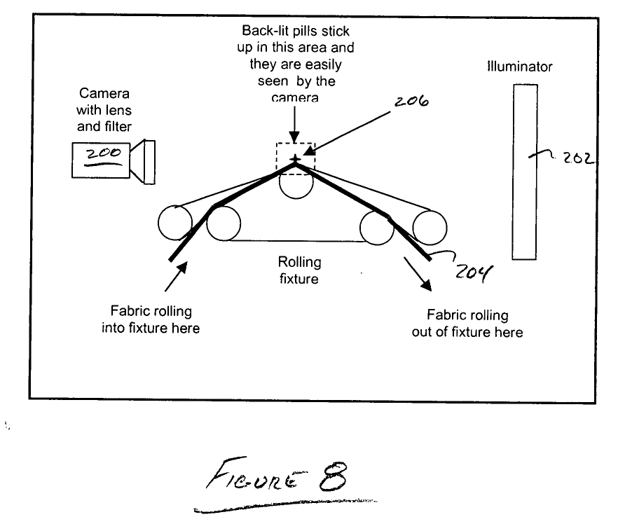

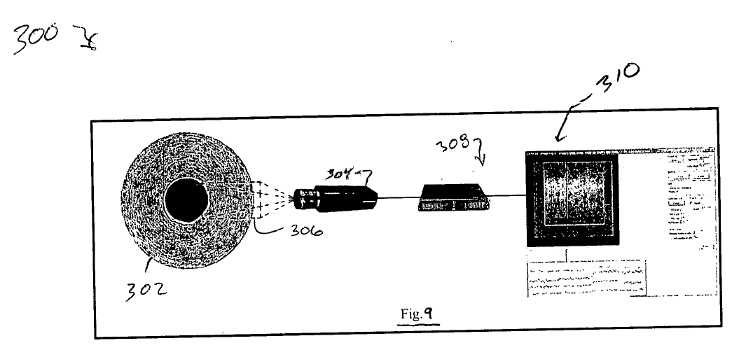

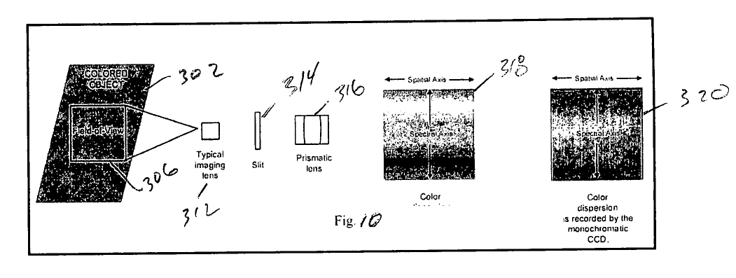

FIG. 1 illustrates a fabric inspection and grading apparatus 10, in accordance with one embodiment of the present invention. As shown in FIG. 1, the fabric inspection and grading apparatus 10 includes an inspection housing 12 and a computer controlled instruction and display device 14. The inspection housing 12 supports a feed table 16 for accepting fabric swatches 18, an open receiving bay 20 and a CPU compartment 22 for retaining known computer and computer-related devices capable of receiving and implementing machine language instructions.

It will be readily appreciated that the computer controlled instruction and display device 14 is operatively connected to the housing 12, as well as the computer and computer-related devices within the CPU compartment 22, in a known manner so as to enable the exchange of information and instructions therebetween.

The feed table 16 is preferably size to accommodate standard fabric swatches which are approximately 105 mm×105 mm for the standardized American Society of Testing and Measurements (ASTM) test, and 140 mm in diameter for the International Standards Organization (ISO) test. The present invention is not limited in this regard, however, as the feed table 16 may be sized to accommodate any size fabric or fabric swatch without departing from the broader aspects of the present invention.

Returning to FIG. 1, a motor drive 24 is integrally mounted to the housing 12 and drives an mandrel assembly (unillustrated in FIG. 1) to propel the fabric swatches 18 through the fabric inspection and grading apparatus 10. Once inspected, the fabric swatches 18 will be deposited into the receiving bay 20, as will be described in more detail below.

In order to accomplish the inspection and grading of the fabric swatches 18, the fabric inspection and grading apparatus 10 utilizes consecutive images of the fabric swatches 18 as taken across a moving horizon of the fabric swatches 18.

FIG. 2A illustrates one embodiment of the mandrel assembly 26, driven by the motor drive 24, which transports the fabric swatch 18 for imaging by a recording apparatus 28. As shown in FIG. 2A, the mandrel assembly 26 includes a number of drive rollers 30 and associated belts 32. It will be readily appreciated that the belts 32 are sufficiently tensioned about the drive rollers 30 such that movement of the drive rollers 30 via the motor drive 24 will precipitate a corresponding movement in the belts 32. Moreover, the belts 32 are preferably fashioned to have a measure of inherent tactile adhesion. That is, the belts 32 are capable of releasably entraining the fabric swatch 18 by providing a gripping force to the planar surface of the fabric swatch 18. The belts may therefore be fabricated from a rubberized material, or the like, and may also have a series of ribs, lands or other protrusion formed on the surface thereof.

Although the mandrel assembly 26 has been described as being configured as a belt driven feed device in FIG. 2A, the present invention is not limited in this regard as alternative configurations are equally contemplated. A simpler pinch rod 27 and drive wheel 29 configuration is shown in FIG. 2B and comprise a mandrel assembly 31, wherein like numerals perform substantially the same task in substantially the same manner as does the mandrel assembly 26 and recording apparatus 28 discussed in association with FIG. 2A.

In the embodiment shown in FIG. 2B, the pinch rod 27 includes two separate wheels that press upon and transverse the fabric swatch 18, so as to pinch the fabric swatch 18 against the drive wheel 29. As will be appreciated, the dual wheels of the pinch rod 27 travel along the outer edges of the fabric swatch 18, thus leaving the center between the two wheels of the pinch rod 27 open for inspection by the recording apparatus 28. Thus the moving horizon of the fabric swatch 18 can be imaged, as will be explained hereinafter.

In consideration once again of FIG. 2A, the primary purpose of the mandrel assembly 26 (as well as the mandrel assembly 31) is to hold and feed the fabric swatch 18 at a substantially constant speed while the recording apparatus 28 images the moving horizon of the fabric swatch 18. As also shown in FIG. 2A, once the fabric swatch 18 has been placed onto the feed table 16 and entrained by the drive rollers 30 and the belts 32, the fabric swatch 18 will be bent about a center roller 34 to define an ever-changing and substantially linear horizon, shown on end as a horizon viewpoint 36.

The recording apparatus 28 images the horizon viewpoint 36 along a line-of-sight optical path 38. A back light 40 provides illumination for this purpose while the silhouette-like image of the horizon viewpoint 36 is reflected off of a mirror 42 and to the recording apparatus 28. The back light 40 is preferably an acrylic plate illuminated by monochromatic LEDs to create an even and narrow spectral light source. Moreover, the acrylic plate of the back light 40 is polished on the edges, and may be roughly sanded on the flat surface nearest the fabric swatch 18. The back-light further includes a mirror 44 adhered to the back surface thereof. The LEDs preferably output a monochromatic spectral light and are mounted so as to direct their light into, and at substantially a right angle to, the edges so that the rough surface and mirror 44 internally scatter the light, creating an even illuminated light plate of a single wavelength that is used as background illumination to profile the horizon viewpoint 36. The lens of the recording apparatus 28 is outfitted with a narrow band pass filter that only transmits the LED's monochromatic light output, which eliminates any stray light colors and achieves a high contrast image and is therefore helpful to the subsequent image processing.

As will be appreciated, the recording apparatus 28 is preferably a digital or analog video camera capable of feeding the silhouette-like image of the horizon viewpoint 36 to the CPU compartment 22, and thus, to the computer controlled instruction and display device 14. Each of the standard-sized fabric swatches 18 are preferably fed through the mandrel assembly 26, and therefore across the field of view of the recording apparatus 28, in a predetermined period of time, preferably within 5 seconds. The recording apparatus 28 therefore captures images every 1/30 or 1/60 second, wherein each image captured is a separate image of a silhouette-like horizon viewpoint 36 of the fabric swatch 18. The roll speed of the mandrel assembly 26, the frame rate of the recording apparatus 28, and the image acquisition duration are all set so that the entire acquired video image contains sequential, horizon images of the fabric swatch 18.

It is therefore an important aspect of the present invention that the recording apparatus 28 is capable of objectively and clearly imaging any pills or snags present upon the surface of the fabric swatch 18.

As illustrated in the sequential images shown in FIG. 3, a detection and evaluating computer program is utilized to evaluate the images obtained by the recording apparatus 28. In this regard, it will be readily appreciated that the detection and evaluating computer program represents machine readable code and may take any known form or be expressed in any known machine language, provided that the detection and evaluating computer program is capable of accepting, marking and evaluating the images received by the recording apparatus 28 in a manner as described below.

Returning to FIG. 3, each sequential, raw horizon image 49 of the fabric swatch 18 is captured in sequence as a video image and is processed individually in real time to count, locate, and size the pills and snags 52. The pills and snags 52 are detected, in the preferred embodiment of the present invention, by first applying a variable binary threshold to the raw horizon image 50 so as to obtain a binarized image 54. Once so identified and refined, the location of each of the pills and snags 52 in the binarized image 54 are then identified by the detection and evaluating computer program and identified as a series of ticks 56.

As will be appreciated by a review of FIGS. 1 and 3 in combination, the computer controlled instruction and display device 14 will display a graphical representation of the detected pills and snags 52 by generating a virtual outline 58 of the fabric swatch 18, including the relative location of the ticks 56 thereon. The size and shape of the fabric swatch 18 may be entered into the computer controlled instruction and display device 14 prior to any inspection of the fabric swatch 18, via an automated or manual means. In a preferred embodiment, an operator of the computer controlled instruction and display device 14 will indicate the size and shape of the fabric swatch 18 being processed by the fabric inspection and grading apparatus 10, including if the fabric swatch 18 is one of a known size and shape, as discussed previously.

Also in accordance with a preferred embodiment of the present invention, the size of the displayed ticks 56 will be proportionate to the size of the detected pills and snags 52, however the present invention is not limited in this regard. An alternative method contemplated by the present invention involve displaying the varying size of the detected pills and snags 52 as differing colored ticks 56. Moreover, the present invention also contemplates displaying all of the ticks 56 in a uniform color and size, whereas the relative size information of the pills and snags 52 is acknowledged only by the detection and evaluating computer program.

Once the pills and snags 52 have been detected and measured by the fabric inspection and grading apparatus 10, the detection and evaluating computer program will grade the fabric swatch 18 in accordance thereon. That is, as illustrated in FIGS. 4A-4C, the number and size of pills and snags 52 are applied to a formula contained within the detection and evaluating computer program, to establish thereby a grade on the industry accepted grading scale of 1.0-5.0, where 5.0 represents an absence of pilling or snagging, as represented by FIG. 4A; where 3.0 represents moderate pilling or snagging, as represented by FIG. 4B; and where 1.0 represent severe pilling or snagging, as represented by Figure C.

As discussed previously, the fabric inspection and grading apparatus 10 is also capable of determining the fuzziness associated with the fabric swatch 18. FIG. 5B illustrates the fuzz 60 associated with the fabric swatch 18, as clearly imaged using the back light 40, discussed in association with FIGS. 2A and 2B. Alternatively, and as shown in FIG. 5A, a front light 62 may instead be utilized while the back light 40 is turned off to create a image of the fuzz 60, where the fuzz 60 is accentuated for image processing. Irrespective of whether the back light 40 or the front light 62 is utilized to image the fuzz60, FIG. 6 illustrates a quantification of the fuzz 60 wherein the image of the fuzz 60 is binarized from the corresponding grey scale image 70 into a binary image 80, after which the fuzziness is measured and assigned a grade 1.0-5.0 in accordance with a predetermined scaling protocol.

While the present invention has been described as a integrated and stationary apparatus (shown, generally, in FIG. 1), the present invention is not limited in this regard as the fabric inspection and grading apparatus may also be configured to examine rolls of fabric as they are produced. As shown in FIG. 7, a hand-held fabric inspection and grading apparatus 100 includes a housing 102 within which a back light 104, or a front light 106 (depending on the application), may be actuated for illuminating the fabric sheet 108.

As further shown in FIG. 7, a pair of stabilizing rollers 110 are utilized to stabilize the housing 102 against the fabric sheet 108, the pressure and arrangement of which inherently bends the fabric sheet 108 so as to create a moving horizon that a recording apparatus 112 may capture for sequential imaging. The entire assembly may then be tethered to a communication/power cable leading to a mobile control and display device 114.

As shown in FIG. 7, the fabric inspection and grading apparatus of the present invention need not employ a mirror for imaging the moving horizon of the fabric swatch or fabric sheet. Rather, the recording apparatus 112 may be positioned in a direct line-of-sight to the illumination device, or light, 104 without departing from the broader aspects of the present invention. Indeed, as more clearly shown in FIG. 8, the recording apparatus 200 and illumination device 202 need only be disposed on opposing sides of the fulcrum roller 208 provided that the silhouette-like apex portion (or, horizon viewpoint) 206 of the fabric swatch 204, which is temporally redefined along the length of the fabric swatch 204 as the fabric swatch 204 is moved across the fulcrum 208, is arranged therebetween.

The current invention thus allows for the objective acquisition of pilling, snagging and/or fuzziness data and pilling resistance, which in turn enables an objective grading of these characteristics. Quality control data correlation, inter-company technical specification agreement and efficacy are therefore realized in a manner that can be invaluable to the fabric manufacturer, yarn manufacturer, and fabric finisher.

The present invention relates to the pilling, snagging and fuzziness inspection of all different fabric types, including but not limited to non-woven, woven, and knitted fabrics made of all different types of fibers, including but not limited to cotton, glass, wool, polyester, nylon, acrylic, spandex, cellulose, aramids™, kevlar™, nomex™, lyocell™, rayon, blended, and polypropylene.

Furthermore, the present invention relates to both the pilling, snagging and fuzziness inspection and grading of fabrics and fabric samples. This invention can be implemented both in the pilling, snagging and fuzziness inspection of large area fabrics and textile backings as they are rolled within a textile machine and also in the laboratory type inspection of small sample fabric swatches that are cut from larger fabric pieces then abraded using an abrasion machine to simulate long term wear, abrasion, and washings.

The method and apparatus described herein is heretofore unknown and improves upon the existing methodologies in a variety of ways, including making the pilling, snagging and fuzziness test objective, performing tests with greater repeatability, accuracy and precision, and allowing for the easy storage of test data which in turn allows for process improvement analysis and historical data storage.

Turning now to the detection and grading of color in fabrics, FIG. 9 illustrates a simplified layout of a coloration inspection and detection apparatus 300, in accordance with one embodiment of the present invention. As shown in FIG. 9, packages (or fabric objects) 302 are spun, moved or otherwise transported underneath the field of view of the color detection module 304, preferably formed as a CCD camera. As shown in FIG. 9, the CCD camera 304 is viewing the axial end of the fabric object 302, however the present invention may alternatively view an exterior, longitudinal portion of the fabric object 302 without departing form the broader aspects of the present invention.

The object 302 is illuminated evenly by bright illuminating tubes, thereby defining an inspection area 306. Preferably, one or more bright fluorescent tubes run along the spatial width of the inspection area 306 to optimize lighting evenness in line with the eventual spatial axis of the CCD 304. The CCD 304 provides digital or analog output to a CPU unit 308, which re-creates the obtained image via an appropriate software package for display upon a computer controlled instruction and display device 310. The computer controlled instruction and display device 310 includes software algorithms which processes the image to detect color changes within each sample, and further, processes the images in sequence, comparing images to detect color changes in the object as it spins or transports under the field of view of the color detection module.

The display of the computer controlled instruction and display device 310 illustrated in FIG. 9 shows a slight intra-package color variation in the yarn package, where the inner ring is reddish and the outer ring is more greenish. The package rotates on its center axis to provide a sequence of images to the PC for complete analysis. However, note that the package can remain static to get a single image to get a quick color analysis. Also note that FIG. 9 uses a yarn package having an intra-package color variation. The invention also relates to inter-package color differences by comparing color analysis data from different packages and relates to intra-fabric and inter-fabric color variations as well. In the case of fabrics, of course, the fabric web traverses underneath the field of view of the color detection module.

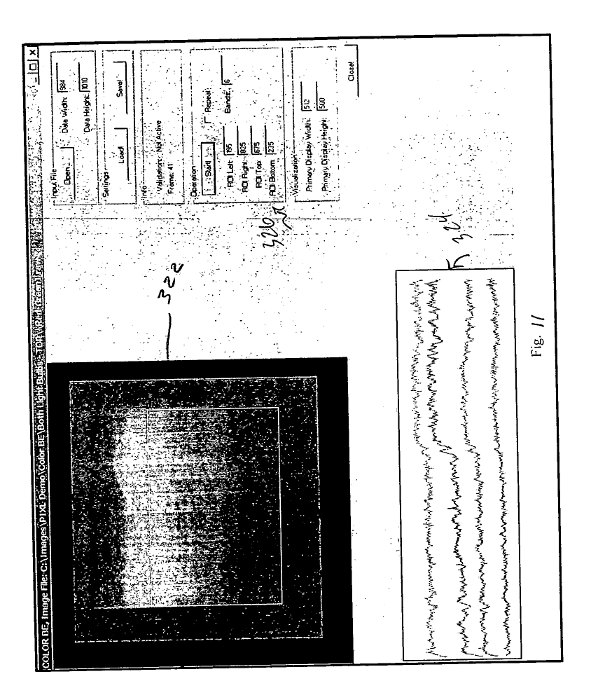

FIG. 10 is a simplified layout of the color detection module, or CCD 310. As the object 302 comes under the field of view of the typical imaging lens 312, the typical imaging lens 312 focuses the object field of view 306 through a slit 314, so that only a small slice of the filed of view enters the prismatic lens (D). A prismatic lens 316 is utilized to disperse the slit of colored light onto the CCD sensor so in a spatial-spectral grid 318. A monochrome CCD sensor records the color dispersion of the object 302 from left to right, where the left side of image 320 corresponds to the left (or bottom) side of the light coming through the slit 314 and the right side of image 320 corresponds to the right (or top) side of the light coming through the slit 314.

FIG. 11 is one possible software screen layout for analyzing the image 322. Depending upon the sensor used, the image 322 can be refreshed along with the movement of the object at speeds up to 120 frames/second. For each image 322, a region of interest is defined (by the white box), where the top corresponds to the boundary between red and infrared, where the bottom corresponds to the boundary between violet and ultraviolet, where the left corresponds to the object's left/bottom spatial limit and the right corresponds to the object's right/top spatial limit. With the need to analyze only the visible color of the object, the white box constrains the algorithm to look only at visible data to optimize processor efficiency.

The algorithm processes the video image 322 to detect both color changes from left to right (corresponding to color changes from left to right within a single image) and color changes from image to image (corresponding to color changes from time period 1 when the first object or object section is in view, to time period 2 when the second (or third, etc.) object or object section is in view. The resultant graph 324 graphically represents the color of the object across the slit's field of view for a single image or for an aggregate of multiple images if so chosen in the settings 326. Notice the graph shift in the middle of graph 324, representing a color shift from the left side of the object to the right side of the object.

Thus, the coloration apparatus of the present invention provides a method and apparatus for the automated color inspection of yarn bobbins and fabrics by illuminating the package and fabric with light, sensing reflection of said light off of the bobbin or fabric through an optical slit and prism module to disperse the reflected light into a spectral array along the vertical axis of an area scan image sensor while the spatial X-dimension of the bobbin or fabric is imaged across the horizontal axis of the image sensor and the spatial Y-dimension of the bobbin or fabric is represented over time at the refresh rate of the video image sensor.

Moreover, the coloration apparatus of the present invention provides a method and apparatus to repeat this spectral imaging and processing at a continuous rate while the bobbin or fabric is rotated or traversed through the apparatus' field of view in order to provide real-time on-going spatial-spectral data and inspection over the surface area of the bobbin or fabric, where the aggregate color measurement of the bobbin or fabric represents an overall color measurement for the bobbin or yarn, something unattainable by standard spectrophotometers which can measure color at only 1 sample point on the bobbin or fabric which is insufficient when the bobbin or fabric is multi-colored or color changes need to be measured over large areas.

While the invention had been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. An inspection apparatus for a fabric, comprising:
a fulcrum about which said fabric is bent, said fulcrum defining an apex portion in said fabric where said fulcrum contacts said fabric;
a moving means for moving a length of said fabric across said fulcrum, thereby causing said apex portion to be temporally redefined along said length of said moving fabric;
an illumination means for projecting a light upon one side of said temporally redefined apex portion; and
a recording device for recording a horizon image of said temporally redefined apex portion, said horizon image being back lit by said illumination means.
